(19) United States
(12) Patent Application Publication
(10) Pub. No.: US 2015/0236985 A1
(43) Pub. Date: Aug. 20, 2015

(54) Optimizations for Frequent Small Data Transmission

(71) Applicants: Devaki Chandramouli, Plano, TX (US); Rainer Liebhart, Munich (DE)

(72) Inventors: Devaki Chandramouli, Plano, TX (US); Rainer Liebhart, Munich (DE)

(73) Assignee: NOKIA SOLUTIONS AND NETWORKS OY, Espoo (FI)

(21) Appl. No.: 14/424,799

(22) PCT Filed: Aug. 31, 2012
(86) PCT No.: PCT/US12/53435

§ 371 Date: Apr. 1, 2015

(51) Int. Cl. H04L 12/861; H04W 76/04; H04W 28/02; H04L 12/805; H04L 12/859

(52) U.S. Cl. CPC H04L 49/9057; H04L 47/36; H04L 47/2475; H04W 28/0289; H04W 76/045

(57) ABSTRACT

Communication systems, such as an evolved packet system, may benefit from optimizations for frequent small data transmissions. In particular, certain communication systems in which mobile applications require numerous keep-alive messages or presence information may benefit from optimizations to state transitions between active and idle states. A method may include detesting a plurality of small packets that are mobile terminated. The method may also include indicating an inactivity time based on the detecting of the small packets and providing this indication in user plane packets or control signaling to the radio access network.

### BACKGROUND

1. Field

Communication systems, such as an evolved packet system, may benefit from optimizations for frequent small data transmissions. In particular, certain communication systems in which mobile applications require numerous keep-alive messages or presence information may benefit from optimizations to state transitions between active and idle states.

2. Description of the Related Art

The evolved packet system (EPS), the successor of general packet radio system (GPRS), provides radio interfaces and packet core network functions for broadband wireless data access. EPS core network functions include the mobility management entity (MME), the packet data network gateway (PDN-GW) and the Serving Gateway (S-GW). An example of an evolved packet core architecture is illustrated in FIG. 1 and is described by third generation partnership project (3GPP) technical specification (TS) 23.401, which is incorporated herein by reference in its entirety. A common packet domain core network can be used for both radio access networks (RANs), the global system for mobile communication (GSM) enhanced data rates for GSM evolution (EDGE) radio access network (GERAN) and the universal terrestrial radio access network (UTRAN). This common core network (CN) can provide general packet radio service (GPRS) services.

FIG. 2 illustrates an overall policy charging and control (PCC) architecture, including roaming with home routed access, when subscription profile repository (SPR) is used. The PCC architecture can extend the architecture of an internet protocol connectivity access network (IP-CAN), where the policy and charging enforcement function (PCEF) is a functional entity in the Gateway node implementing the IP access to the PDN.

As shown in FIG. 2, a home policy and charging rules function (H-PCRF) is connected to the PCEF, residing in a gateway, over Gx. The PCEF is connected to an offline charging system (OFCS) over Gz. The PCEF is connected to service data flow based credit control function in an online charging system (OCS) over Gy. The OCS is, in turn, connected to the H-PCRF over Sy. Rx connects the H-PCRF to an application server (AF), while Sp connects the H-PCRF to the SPR. A visited PCRF (V-PCRF), in a visited public land mobile network (VPLMN) can be connected to the H-PCRF, in the home public land mobile network (HPLMN) via S9. The V-PCRF may also be connected to a bearer binding and event reporting function (BBERF) over Gxx.

Some always on mobile data applications, such as instant messaging (IM), social networking apps, and the like, are currently causing major challenges to operator networks. In particular, frequent small data transmission, also referred to as message storm, may be significant due to diverse applications. Proliferation in the use of smart phones and tablet devices and the diverse mobile data applications running in mobile networks may add to frequent small data transmission.

In general, these mobile data applications involve interactive communications, through operator network, with their application servers in the Internet. The server and the application on the user equipment (UE) periodically exchange heartbeat messages, also known as keep-alives, to keep the application session alive and also to avoid the expiry of network address translation (NAT) mapping which can cause internet protocol (IP) session disconnection. Small data packets are exchanged frequently when mobile data application runs on a UE. Here, a UE may broadly include devices such as smart phones, tablets, personal digital assistants, as well as other terminal devices including meters, even if they are only infrequently accessed by a user.

In addition to periodic keep-alive messages, the applications can also generate frequent status update messages to notify the users of status updates relating to the application. Some examples include presence information of buddies in an IM buddy list, update of user location upon user check-in, update of social networking activity to a user's friends, and the like.

Additionally, these messages can be mobile-originated (MO), mobile-terminated (MT), or both. For example, periodic FindMe messages can come from change of location of a user's friends or can come from the updates of the user's own location.

Moreover, it is common that a UE will install multiple applications, where each application generates these update/keep-alive messages autonomously and independently of one another.

FIG. 3 illustrates the timing when the user equipment experiences frequent idle-active state transitions. As shown in FIG. 3, when the UE constantly flips between active and idle state, there are two observable effects.

A first observable effect is increased control plane signaling. There may be a significant amount of signaling overhead, both in the radio access network (RAN) and in the core network (CN), just to send these occasional, very small update messages. To send just one update message, it may take one round of idle-active transition which may incur significant signaling overhead, including multiple radio resource control (RRC) messages in the RAN and EPC signaling messages (e.g. Service Request, Connection Setup/Release). The RRC messages can include, for example, service request, radio bearer establishment/release, and paging when message is mobile terminating.

Another observable effect is reduced battery life of the user equipment. In a worst case scenario, when multiple applications generate update messages soon after the phone enters idle state, the energy consumption of the phone can increase due to constantly flipping between active and idle states, and thus may be higher than if the phone had just remained in active, connected state.

Smart phone optimizations can include power consumption preference and mobility pattern indications from the UE. These indications can be taken into consideration by the eNode B (eNB) to address signaling load due to handover (HO) vs. idle/connected state transition. These approaches may deal with the impact of frequent small data transmission on the uplink, for example mobile originated packets, but not on the downlink, for example mobile terminated small packets.

There is no conventional solution to address the frequent idle/active transition, for example, frequent paging/service request procedure, caused due to frequent small data transmission in the downlink without causing additional end-to-end signaling between the network and the UE.

### SUMMARY

According to a first embodiment, a method includes detecting a plurality of small packets that are mobile terminated. The method also includes indicating an inactivity time based on the detecting of the small packets.

According to a second embodiment, a method includes receiving an inactivity time corresponding to a user equipment based on at least one downlink traffic criterion. The method also includes evaluating a length of the inactivity time. The method further includes determining the behavior of the user equipment based on the evaluating.

According to a third embodiment, a method includes determining that a traffic detection function has detected at least one of operation of a previous application or a start of operation of a new application. The method also includes upgrading or downgrading a quality of service of a user equipment in downlink in response to the determining and without notifying the user equipment.

In a fourth embodiment, an apparatus includes at least one processor and at least one memory including computer program code. The at least one memory and the computer program code are configured to, with the at least one processor, cause the apparatus at least to detect a plurality of small packets that are mobile terminated. The at least one memory and the computer program code are also configured to, with the at least one processor, cause the apparatus at least to indicate an inactivity time based on the detecting of the small packets.

In a fifth embodiment, an apparatus includes at least one processor and at least one memory including computer program code. The at least one memory and the computer program code are configured to, with the at least one processor, cause the apparatus at least to receive an inactivity time corresponding to a user equipment based on at least one downlink traffic criterion. The at least one memory and the computer program code are also configured to, with the at least one processor, cause the apparatus at least to evaluate a length of the inactivity time. The at least one memory and the computer program code are further configured to, with the at least one processor, cause the apparatus at least to determine the behavior of the user equipment based on the evaluating.

In a sixth embodiment, an apparatus includes at least one processor and at least one memory including computer program code. The at least one memory and the computer program code are configured to, with the at least one processor, cause the apparatus at least to determine that a traffic detection function has detected at least one of operation of a previous application or a start of operation of a new application. The at least one memory and the computer program code are also configured to, with the at least one processor, cause the apparatus at least to upgrade or downgrade a quality of service of a user equipment in downlink in response to the determining and without notifying the user equipment.

An apparatus, in a seventh embodiment, includes detecting means for detecting a plurality of small packets that are mobile terminated. The apparatus also includes indicating means for indicating an inactivity time based on the detecting of the small packets.

An apparatus, in an eighth embodiment, includes receiving means for receiving an inactivity time corresponding to a user equipment based on at least one downlink traffic criterion. The apparatus also includes evaluating means for evaluating a length of the inactivity time. The apparatus further includes determining means for determining the behavior of the user equipment based on the evaluating.

An apparatus, in a ninth embodiment, includes determining means for determining that a traffic detection function has detected at least one of operation of a previous application or a start of operation of a new application. The apparatus also includes quality control means for upgrading or downgrading a quality of service of a user equipment in downlink in response to the determining and without notifying the user equipment.

In tenth, eleventh, and twelfth embodiments, a non-transitory computer-readable medium encoded with instructions that, when executed in hardware, performs a process, where the process includes the method of respectively the first, second, and third embodiments.

### BRIEF DESCRIPTION OF THE DRAWINGS

For proper understanding of the invention, reference should be made to the accompanying drawings, wherein:

FIG. 1 illustrates an evolved packet core architecture.

FIG. 2 illustrates an overall policy charging and control (PCC) architecture, including roaming with home routed access, when subscription profile repository (SPR) is used.

FIG. 3 illustrates the timing when the user equipment experiences frequent idle-active state transitions.

FIG. 4 illustrates the communication of a downlink (DL) traffic inactivity time indication using GTP-C, according to certain embodiments.

FIG. 5 illustrates storage of and retrieval of inactivity time, according to certain embodiments.

FIG. 6 illustrates modified QoS parameters indication using GTP-C, according to certain embodiments.

FIG. 7 illustrates a method according to certain embodiments.

FIG. 8 illustrates another method according to certain embodiments.

FIG. 9 illustrates a system according to certain embodiments.

FIG. 10 illustrates a method according to certain embodiments.

### DETAILED DESCRIPTION

Smart phone and other applications may generate high signaling load due to frequent small data transmission, leading to a suboptimal relation between idle and active state of a handset, particularly with respect to power consumption, as described above. Keeping a user equipment (UE) in connected state for longer than conventionally done may reduce the number of active/inactive transitions, but may negatively impact a user equipment's battery consumption. On the other hand, transmission can only happen when the UE is in connected state. Thus, certain embodiments provide for an intelligent determination of trade-off between UE staying in connected state versus idle state. For example, inactivity timer value can be a compromise between signaling load and power consumption, thus certain embodiments can set this value intelligently.

More particularly, certain embodiments address the high frequency of paging/service request procedures caused due to frequent small data transmission on the downlink. Certain embodiments specifically address RRC parameters, especially RRC Release timer, adaptation, as well as radio resource optimization based on traffic pattern in the downlink, for example dynamic traffic/static traffic adaptation. Moreover, certain embodiments specifically address application based quality of service (QoS) control without initiating bearer modification procedure for signaling reduction and resource optimization

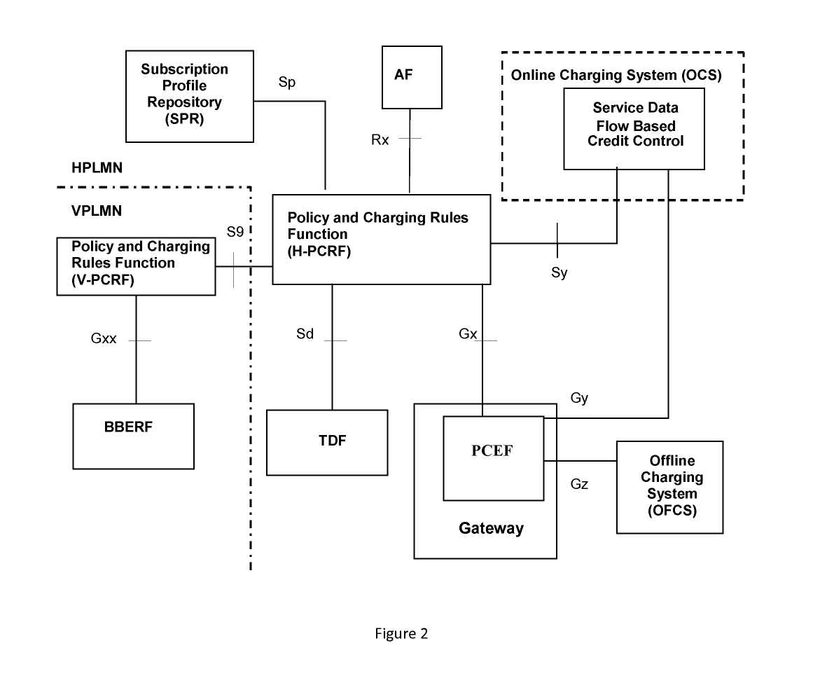

In certain embodiments, a traffic detection function (TDF), shown in FIG. 2, may be used to detect service flows belonging to a certain application. Monitoring may also be performed at the TDF by pre-configuration. Frequency and duration for this type of traffic monitoring and the type of application that should be monitored can be pre-configured. A TDF can also be referred to as a deep packet inspection (DPI) function. The function can be a standalone function or can be collocated with a packet gateway (P-GW)/gateway general packet radio system (GPRS) support node (GGSN). Application layer monitoring can also be performed by special application level gateway or application layer gateway (ALG) functions residing in the network.

Such detection can be performed in order to monitor the traffic pattern, including size of packets, number of packets, and inter-arrival time between packets, so as to intelligently set an inactivity time on a per user equipment basis and to provide this inactivity time to the radio access network (RAN). This inactivity time can be provided to the RAN using user plane (UP), such as directly in the IP header or the GPRS tunneling protocol (GTP-U) header of the packet transmitted, to avoid additional signaling overhead. Alternatively, this inactivity time can also be indicated using control plane (e.g. GTP-C) messages.

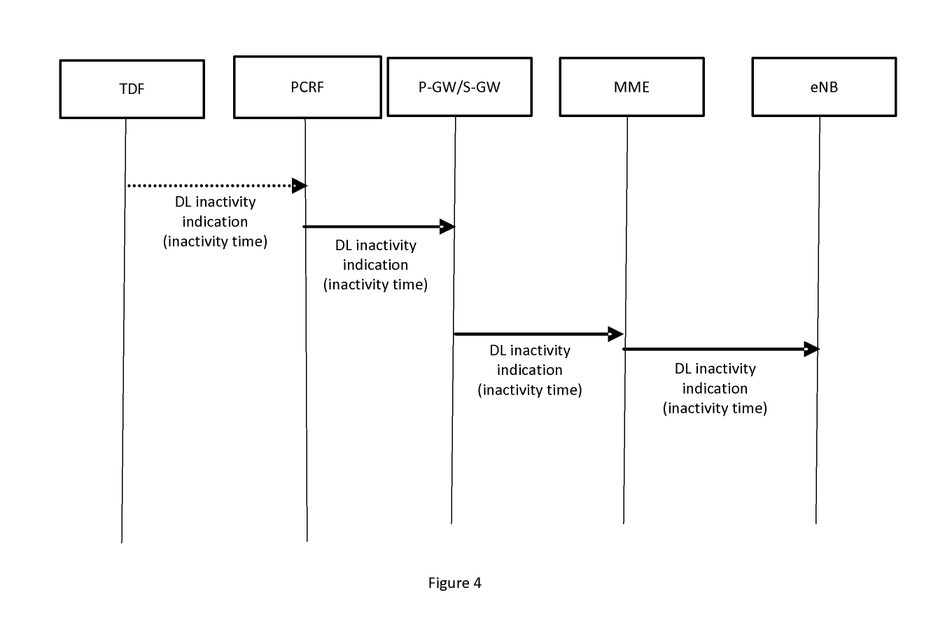

FIG. 4 illustrates the communication of a downlink (DL) traffic inactivity time indication using GTP-C, according to certain embodiments. If the TDF is collocated with the P-GW/GGSN, then the inactivity time can be provided from P-GW/GGSN to eNB using GTP-C messages. If TDF is standalone, then the TDF can provide the inactivity time to a policy and charging rules function (PCRF) which, in turn, can send the inactivity time to the P-GW to forward this to RAN.

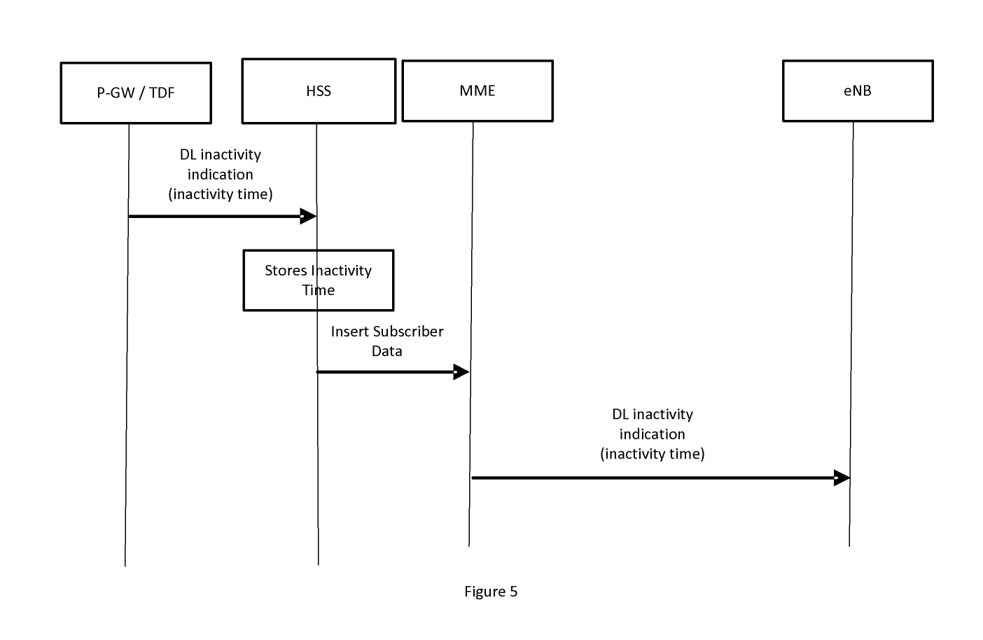

FIG. 5 illustrates storage of and retrieval of inactivity time, according to certain embodiments. To avoid performing this monitoring constantly, the TDF can profile a user's behavior. For example, the TDF, or another network element, can monitor and analyze traffic characteristics of a user equipment over a period of time and then decide when and how often the TDF should set/change the value for inactivity time, for example, through PCRF and P-GW/GGSN. Alternatively, inactivity time can also be stored in the home subscriber server (HSS) subscription data on a more permanent basis, if the device's traffic characteristics do not change very much over time. This requires a new interface from PCRF or TDF to HSS, or from P-GW to HSS. Alternatively, TDF can store the inactivity time in the subscriber profile repository (SPR), shown in FIG. 2 above (optionally done via the PCRF), or the P-GW can provide the inactivity timer in the authentication, authorization, and accounting (AAA) server, which can then forward it to the HSS.

Thus, one option may be to determine inactivity time based on dynamic detection of small packets and inter-arrival time for small packets. Another option may be to profile the user after a certain period of time and store this inactivity time in the HSS. This inactivity time can then be sent to the RAN when a connection is established. This may help avoid constant dynamic detection and may save processing time.

The HSS can then download this value to the mobility management entity (MME) while providing subscription parameters which in turn can be provided to the eNB.

In combination, dynamic traffic adaptation based on dynamic traffic detection can be used for a period of time. Then, once the characteristics of the UE's traffic are determined, static traffic adaptation may be performed. Static traffic adaptation can refer to adaptation based on a value stored in the HSS. If the inactivity time is stored in the SPR, the SPR can download it to the PCRF, which may then provide it to the eNode B (eNB) via the P-GW by including this in the signaling during bearer establishment procedure.

As mentioned above, operators can configure within the TDF when to switch back to dynamic traffic adaptation. Such a further dynamic adaptation can override the parameters stored in the HSS or SPR. An intelligent TDF can also override parameters stored in the HSS or SPR and change parameters dynamically when it detects that the device's traffic pattern has changed significantly.

The RAN can use this information to intelligently set the inactivity timer used for RRC connection release, due to inactivity, and this may help to avoid frequent active to idle state transitions.

If the inactivity time is low, for example thirty seconds, then the RRC release timer, for example the inactivity timer, can be set to a value based on an indication from the core network, to ensure that the UE remains in the connected state until the next packet arrives.

If the duration of inactivity time is high, for example more than three minutes, then the eNB can decide to set the inactivity timer based on other parameters, such as uplink traffic characteristics or determined by the eNB itself based on average data activity (i.e. average heart-beat time), mobility pattern (e.g. average HO status). Thus, the eNB can determine the inactivity timer value based on downlink traffic arrival rate using parameters provided by the core network, uplink traffic arrival rate, or mobility pattern, such as average hand-over (HO) status. The uplink arrival rate can be based on parameters provided by the user equipment or determined by the eNB itself based on average data activity, such as average heart-beat time.

Intelligently setting the inactivity timer value may help the eNB to optimize signaling due to connected state handover. For instance, if the inactivity time is high, the eNB can decide to move the user equipment to idle state versus keeping it connected, to avoid signaling overhead due to HO in the connected state. This determination can also be based on an intelligent indication from the core network about DL traffic characteristics, for example an implicit inactivity time indicator, and on an indication from the user equipment about uplink traffic characteristics/mobility pattern.

The RAN can also use inactivity time provided based on dynamic traffic characteristics as an implicit indication that the ongoing transmission is mainly due to small packets/keep-alive messages. Thus, the RAN can use this as an indication to optimize resources allocated for user plane in the downlink.

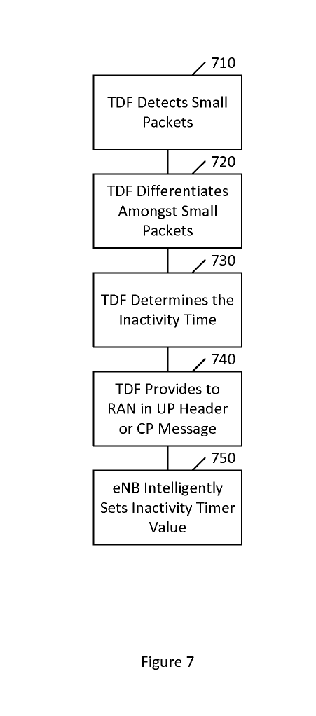

FIG. 7 illustrates a method according to certain embodiments. The method of FIG. 7 may correspond, for example, to the flows illustrated in FIGS. 4-5. As shown in FIG. 7, at 710, a TDF, broadly including a DPI or an ALG within the category of TDF, can detect the small packets.

Then, at 720, the TDF can optionally have the ability to differentiate between the small data packet and keep-alive messages, sometimes referred to as heart beat messages. Thus, small packets can include both small data packets and keep-alive messages. Based on the inter-arrival time for the keep-alive packets or small packets, at 730 the TDF can determine the inactivity time.

Subsequently, at 740, the TDF can provide this inactivity time to the RAN either in a UP header or as a CP message. The inactivity time can be indicated for a particular user equipment, for example, on a per user equipment basis. Moreover, inactivity time determination and indication of the inactivity time can be performed periodically or when triggered by detection of a start or end of an application.

Finally, at 750, the eNB can intelligently set the inactivity timer value such that the UE remains connected if the inter-arrival/inactivity time is small enough. Moreover, if the inter-arrival/inactivity time is too long, then the eNB can set the inactivity timer value to a default value or can set the inactivity timer value based on other parameters, such as uplink characteristics, to release the connection and move the UE to idle state.

The above approach may address frequent active/idle state transitions and frequent paging/service request procedures and may also ensure that user equipment battery consumption is optimized.

In certain additional embodiments, it is taken into account that different applications have different demands for quality of service (QoS) and that operators may want to be able to modify packet data protocol (PDP) context or packet data network (PDN) connections depending on application usage. This approach may entail using the TDF to detect particular traffic and to initiate an upgrade or downgrade of QoS. Normally, QoS modification is applied end-to-end, which may require a bearer modification procedure that results in additional signaling.

Certain embodiments avoid additional signaling while modifying the QoS in the downlink. Such embodiments may involve the P-GW/GGSN, if collocated with TDF, indicating the modified QoS parameters, such as QoS class identifier (QCI) or allocation-retention priority (ARP), or new values, such as new priority values, on top of QCI/ARP either. These parameters may be indicated to the RAN using the control plane, such as GTP-C, or using the user plane, such as IP header or header of GTP-U packets.

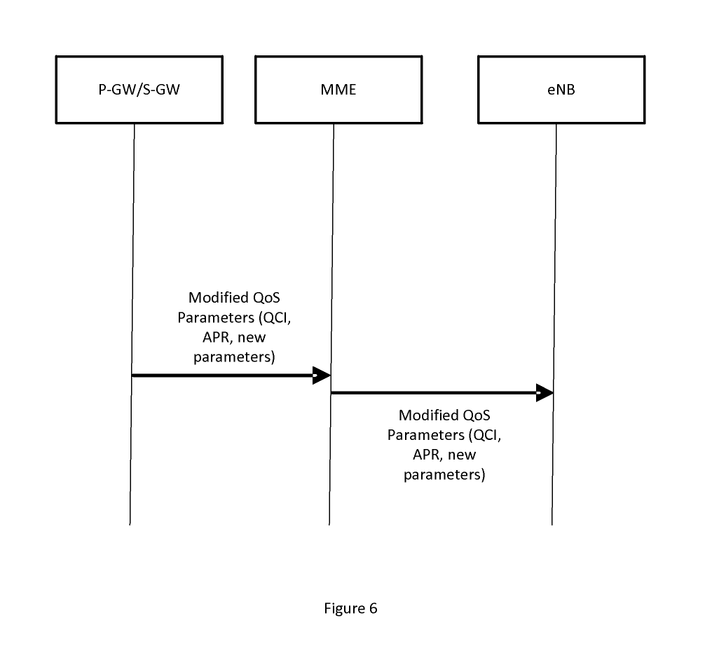

FIG. 6 illustrates modified QoS parameters indication using GTP-C, according to certain embodiments. As shown in FIG. 6, not every user plane packet needs to be marked. It may be sufficient to indicate the start and stop of the application using a GTP-U header or apply a certain behavior for all packets as long as the earlier received marking is not overwritten with a new marking. Modified QoS parameters for the bearer can also be indicated by marking a single user plane packet. Alternatively, start and stop of the application can be indicated using control plane messaging from P-GW to eNB. It is possible to avoid signaling to the UE to modify QoS in the downlink since it is the eNB that enforces the maximum bit rate (MBR)/aggregate maximum bit rate (AMBR) for guaranteed bit rate (GBR)/non-GBR bearers, as discussed in 3GPP TS 36.300, and notification to the UE is not performed.

Certain embodiments, therefore, provide on-the-fly bearer QoS modification without notifying the UE and using control plane signaling but just signaling changed QoS values for the bearer or marking modified QoS parameters in user plane packets. A single user plane packet can be used or a pair of user plane packets can be used to indicate start and stop of the application.

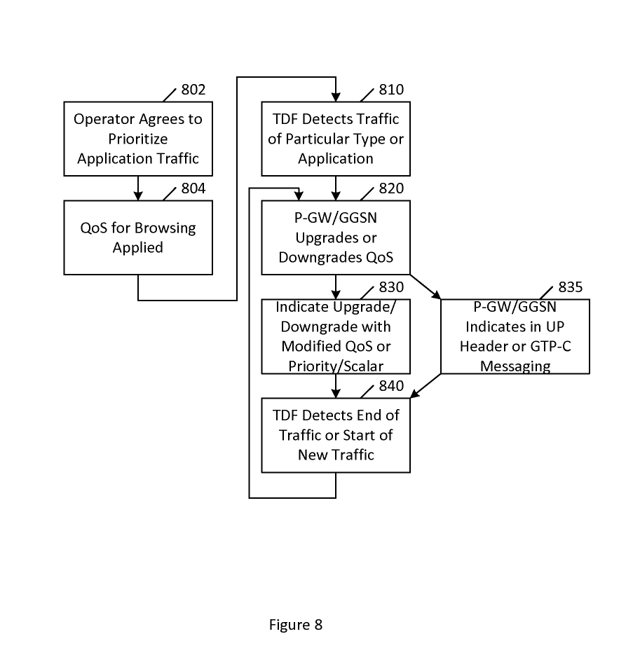

FIG. 8 illustrates another method according to certain embodiments. The method of FIG. 8 may correspond, for example, to the flow illustrated in FIG. 6. As shown in FIG. 8, at 802, an operator may enter into arrangements with application providers to prioritize traffic that belongs to the application provider to improve quality of experience. Then, at 804, a first QoS, QoS x, may be applied when a user is browsing.

At 810, a TDF may detect a particular traffic or traffic type, such as online gaming or small data transmission. Then, at 820, triggered by the TDF, P-GW/GGSN may initiate the upgrade or downgrade of QoS x to a second QoS, QoS y.

At 830, the upgrade or downgrade of QoS can be indicated by modified QoS values (for example, modified QCI, ARP) to retain same processing functionality within the eNB or this upgrade or downgrade can be indicated by an added priority/scalar on top of ARP/QCI. Likewise, at 835, the P-GW/GGSN can indicate the upgrade or downgrade either using an UP header or using GTP-C messaging.

At 840, when TDF detects the end of particular traffic or beginning of a new application, such as video, it can trigger P-GW/GGSN as described above, at 820.

This on-the-fly QoS modification can help to reduce signaling with the UE caused due to bearer modification and can also help to optimize resources allocated for the bearer based on dynamic traffic characteristics.

In general, various embodiments may provide the ability for the radio network to optimize resources and set RRC release timer based on dynamic traffic characteristics. For example, certain embodiments may address frequent active/idle state transition and frequent paging/service request procedures. Certain embodiments may also ensure UE battery consumption is optimized.

Dynamic traffic adaptation as present in certain embodiments can also help optimize radio resources allocated for user plane. Moreover, certain embodiments offer application prioritization based on application detection and at the same time help to reduce signaling. Furthermore, on-the-fly QoS modification can help not only reduce signaling with the UE caused by the bearer modification procedure but also can help optimize resources allocated for the bearer based on dynamic traffic characteristics.

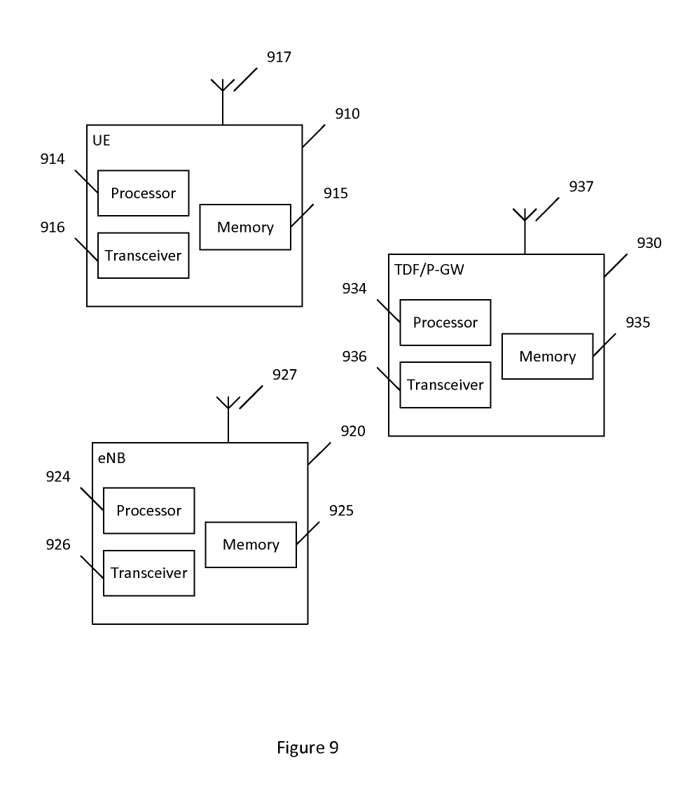

FIG. 9 illustrates a system according to certain embodiments of the invention. In one embodiment, a system may include multiple devices, such as, for example, at least one UE 910, at least one eNB 920, and at least one TDF/P-GW 930. The TDF/P-GW 930 is shown as a single device, but may actually be two separate similar devices in communication with one another.

Each of these devices may include at least one processor, respectively indicated as 914, 924, and 934. At least one memory can be provided in each device, and indicated as 915, 925, and 935, respectively. The memory may include computer program instructions or computer code contained therein. Transceivers 916, 926, and 936 are provided, and each device may also include an antenna, respectively illustrated as 917, 927, and 937. Other configurations of these devices, for example, may be provided. For example, UE 910, eNB 920, and TDF/P-GW 930 may be configured for wired communication, rather than wireless communication, and in such a case antennas 917, 927, and 937 would illustrate any form of communication hardware, without requiring a conventional antenna.

Transceivers 916, 926, and 936 can each, independently, be a transmitter, a receiver, or both a transmitter and a receiver, or a unit or device that is configured both for transmission and reception.

Processors 914, 924, and 934 can be embodied by any computational or data processing device, such as a central processing unit (CPU), application specific integrated circuit (ASIC), or comparable device. The processors can be implemented as a single controller, or a plurality of controllers or processors.

Memories 915, 925, and 935 can independently be any suitable storage device, such as a non-transitory computer-readable medium. A hard disk drive (HDD), random access memory (RAM), flash memory, or other suitable memory can be used. The memories can be combined on a single integrated circuit as the processor, or may be separate therefrom. Furthermore, the computer program instructions stored in the memory and which may be processed by the processors can be any suitable form of computer program code, for example, a compiled or interpreted computer program written in any suitable programming language.

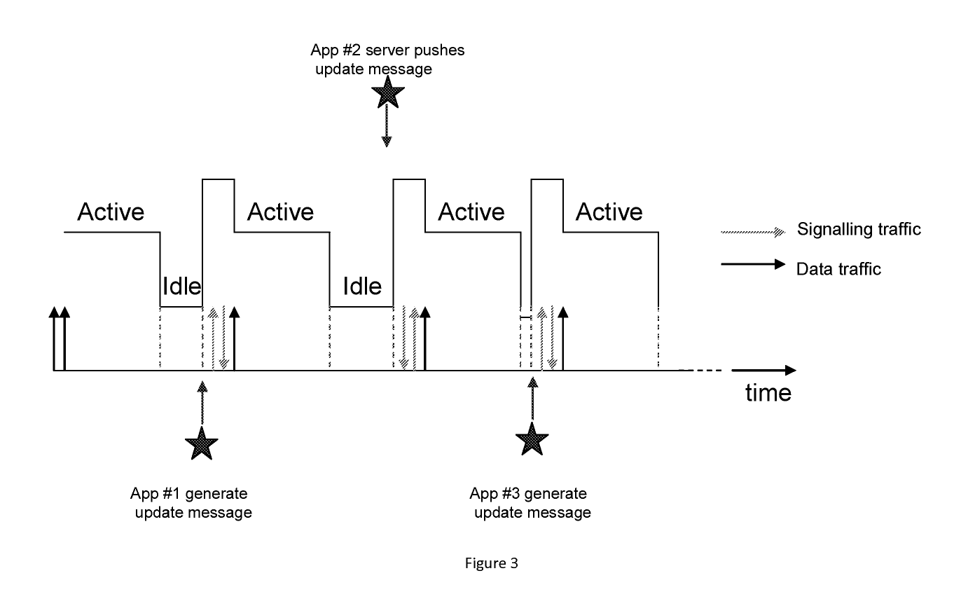

The memory and the computer program instructions can be configured, with the processor for the particular device, to cause a hardware apparatus such as UE 910, eNB 920, and TDF/P-GW 930, to perform any of the processes described above (see, for example, FIGS. 3-8). Therefore, in certain embodiments, a non-transitory computer-readable medium can be encoded with computer instructions that, when executed in hardware, perform a process such as one of the processes described herein. Alternatively, certain embodiments of the invention can be performed entirely in hardware.

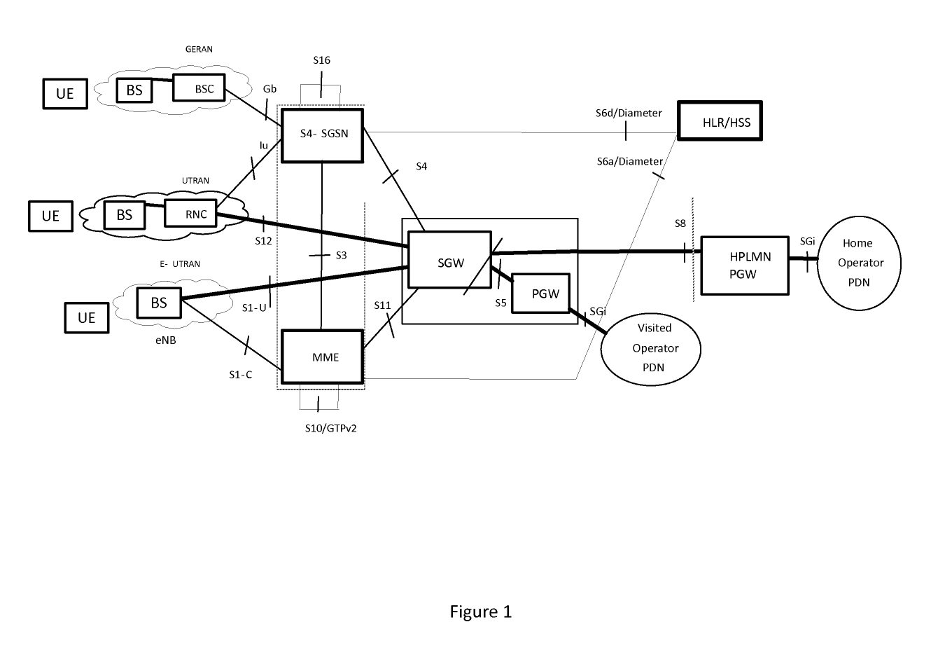

Furthermore, although FIG. 9 illustrates a system including a UE, eNB, and TDF/P-GW, embodiments of the invention may be applicable to other configurations, and configurations involving additional elements, as illustrated herein, for example in FIGS. 1-8 and 10.

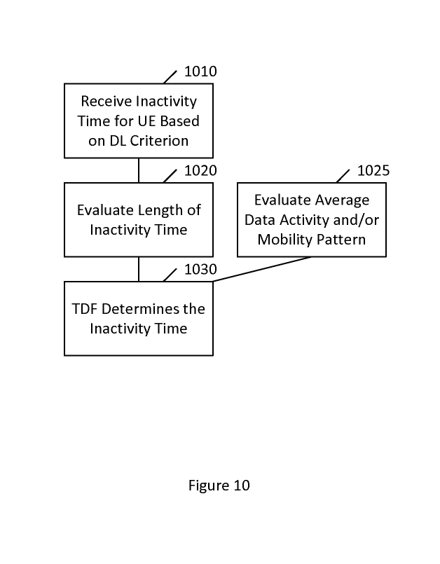

FIG. 10 illustrates a method according to certain embodiments. As shown in FIG. 10, a method can include, at 1010, receiving an inactivity time corresponding to a user equipment based on at least one downlink traffic criterion. The method can also include, at 1020, evaluating a length of the inactivity time. The method can further include, at 1030, determining the behavior of the user equipment based on the evaluating.

The determining the behavior of the user equipment can be based on at least one uplink traffic criterion. The behavior can be determined for a user equipment in connected state. The determining can be further based on evaluating, at 1025, at least one of a determination of average data activity and a mobility pattern.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. For example, certain embodiments may be implemented in all radio access technologies (RATs) including, for example, evolved universal mobile telecommunication system (UMTS) radio access network (E-UTRAN), UTRAN, global system for mobile communication (GSM) enhanced data rates for GSM evolution (EDGE) radio access network (GERAN). In order to determine the metes and bounds of the invention, therefore, reference should be made to the appended claims.

### GLOSSARY

PCRF—Policy and Charging Rules function

P-GW—Packet Data Network Gateway

GGSN—Gateway GPRS Support Node

TDF—Traffic Detection Function

MME—Mobility Management Entity

SGSN—Serving GPRS Support Node

SPR—Subscription Profile Repository

DPI—Deep Packet Inspection

ALG—Application Level/Layer Gateway

UP—User Plane

CP—Control Plane

GTP—GPRS Tunneling Protocol

1. A method, comprising:
detecting a plurality of small packets that are mobile terminated; and
indicating an inactivity time based on the detecting of the small packets or inactivity time stored in a home subscriber server.

2. The method of claim 1, further comprising:
identifying a type of the small packets, wherein the indicating the inactivity time is further based on the type of the small packets.

3. The method of claim 2, wherein the identifying comprises differentiating between a small data packet type and a keep-alive message type.

4. The method of claim 1, further comprising:
signaling the inactivity time to a radio access network in at least one of a user plane packet header or a control plane message.

5. The method of claim 1, wherein the small packets are addressed to a user equipment and wherein the inactivity time is associated with the user equipment.

6. The method of claim 1, wherein the indicating the inactivity time comprises indicating the inactivity time for a particular user equipment.

7. The method of claim 1, wherein the inactivity time determination and indication is performed periodically or when triggered by detection of a start or end of an application.

8. The method of claim 1, wherein the detecting comprises detecting an inter-arrival time of small packets.

9. The method of claim 8, further comprising:
determining the inactivity time based on the inter-arrival time of small packets.

10. A method, comprising:
receiving an inactivity time corresponding to a user equipment based on at least one downlink traffic criterion;
evaluating a length of the inactivity time; and
determining the behavior of the user equipment based on the evaluating.

11. The method of claim 10, further comprising:
determining the behavior of the user equipment based on at least one uplink traffic criterion.

12. The method of claim 11, wherein the behavior determined is for a user equipment in connected state.

13. The method of claim 10, wherein the determining is further based on evaluating at least one of a determination of average data activity and a mobility pattern.

14. A method, comprising:
determining that a traffic detection function has detected at least one of operation of a previous application or a start of operation of a new application; and
upgrading or downgrading a quality of service of a user equipment in downlink in response to the determining and without notifying the user equipment.

15. The method of claim 14, wherein the upgrading or downgrading comprises sending modified quality of service values to an access point.

16. The method of claim 14, wherein the upgrading or downgrading comprises sending an added priority or scalar on top of an existing quality of service class identifier and allocation-retention priority.

17. The method of claim 14, wherein the upgrading or downgrading comprises signaling an indication in a user plane packet header or a control plane message.

18. An apparatus, comprising:
at least one processor; and
at least one memory including computer program code,
wherein the at least one memory and the computer program code are configured to, with the at least one processor, cause the apparatus at least to
detect a plurality of small packets that are mobile terminated; and
indicate an inactivity time based on the detecting of the small packets or inactivity time stored in the HSS.

19. The apparatus of claim 18, wherein the at least one memory and the computer program code are configured to, with the at least one processor, cause the apparatus at least to identify a type of the small packets, wherein the at least one memory and the computer program code are configured to, with the at least one processor, cause the apparatus at least to indicate the inactivity time further based on the type of the small packets.

20. The apparatus of claim 19, wherein the at least one memory and the computer program code are configured to, with the at least one processor, cause the apparatus at least to differentiate between a small data packet type and a keep-alive message type when base the inactivity time on the type of the small packets.

21. The apparatus of claim 18, wherein the at least one memory and the computer program code are configured to, with the at least one processor, cause the apparatus at least to signal the inactivity time to a radio access network in at least one of a user plane packet header or a control plane message.

22. The apparatus of claim 18, wherein the small packets are addressed to a user equipment and wherein the inactivity time is associated with the user equipment.

23. The apparatus of claim 18, wherein the at least one memory and the computer program code are configured to, with the at least one processor, cause the apparatus at least to indicate the inactivity time for a particular user equipment.

24. The apparatus of claim 18, wherein the at least one memory and the computer program code are configured to, with the at least one processor, cause the apparatus at least to perform the inactivity time determination and indication periodically or when triggered by detection of a start or end of an application.

25. The apparatus of claim 18, wherein the at least one memory and the computer program code are configured to, with the at least one processor, cause the apparatus at least to detect an inter-arrival time of small packets.

26. The apparatus of claim 25, wherein the at least one memory and the computer program code are configured to, with the at least one processor, cause the apparatus at least to determine the inactivity time based on the inter-arrival time of small packets.

27. An apparatus, comprising:
at least one processor; and
at least one memory including computer program code,
wherein the at least one memory and the computer program code are configured to, with the at least one processor, cause the apparatus at least to
receive an inactivity time corresponding to a user equipment based on at least one downlink traffic criterion;
evaluate a length of the inactivity time; and
determine the behavior of the user equipment based on the evaluating.

28. The apparatus of claim 27, wherein the at least one memory and the computer program code are configured to, with the at least one processor, cause the apparatus at least to determine the behavior of the user equipment based on at least one uplink traffic criterion.

29. The apparatus of claim 28, wherein the behavior determined is for a user equipment in connected state.

30. The apparatus of claim 27, wherein the determining is further based on evaluating at least one of a determination of average data activity and a mobility pattern.

31. An apparatus, comprising:
at least one processor; and
at least one memory including computer program code,
wherein the at least one memory and the computer program code are configured to, with the at least one processor, cause the apparatus at least to
determine that a traffic detection function has detected at least one of operation of a previous application or a start of operation of a new application; and
upgrade or downgrade a quality of service of a user equipment in downlink in response to the determining and without notifying the user equipment.

32. The apparatus of claim 31, wherein the at least one memory and the computer program code are configured to, with the at least one processor, cause the apparatus at least to upgrade or downgrade by sending modified quality of service values to an access point.

33. The apparatus of claim 31, wherein the at least one memory and the computer program code are configured to, with the at least one processor, cause the apparatus at least to upgrade or downgrade by sending an added priority or scalar on top of an existing quality of service class identifier and allocation-retention priority.

34. The apparatus of claim 31, wherein the at least one memory and the computer program code are configured to, with the at least one processor, cause the apparatus at least to upgrade or downgrade by signaling an indication in a user plane packet header or a control plane message.

35.-52. (canceled)
